(19) United States
(12) Patent Application Publication
(10) Pub. No.: US 2022/0013284 A1
(43) Pub. Date: Jan. 13, 2022

(54) Printed Electrical Steel

(71) Applicant: Siemens Aktiengesellschaft, München (DE)

(72) Inventor: Carsten Schuh, Baldham (DE)

(73) Assignee: Siemens Aktiengesellschaft, München (DE)

(21) Appl. No.: 17/293,837

(22) PCT Filed: Oct. 15, 2019
(86) PCT No.: PCT/EP2019/077887

§ 371 Date: May 13, 2021

(30) Foreign Application Priority Data
Nov. 16, 2018 (EP) 18206780.1

(51) Int. Cl. H01F 41/02; H01F 1/147; B22F 3/10

(52) U.S. Cl. CPC H01F 41/0233; B22F 3/10; H01F 1/147

(57) ABSTRACT

Various embodiments of the teachings herein include a method for producing an electrical sheet from a printing paste comprising: applying a printing paste to a substrate; drying the printing paste on the substrate; transferring the dried printing paste from the substrate to a sintering underlay; thermally treating the printing paste on the sintering underlay; and separating the thermally treated printing paste from the sintering underlay.

### CROSS-REFERENCE TO RELATED APPLICATIONS

This application is a U.S. National Stage Application of International Application No. PCT/EP2019/077887 filed Oct. 15, 2019, which designates the United States of America, and claims priority to EP Application No. 18206780.1 filed Nov. 16, 2018, the contents of which are hereby incorporated by reference in their entirety.

### TECHNICAL FIELD

The present disclosure relates to electrical sheets. Various embodiments include methods for producing an electrical sheet from a printing paste and/or electrical sheets produced by said methods.

### BACKGROUND

Electric machines consist of variously arranged windings through which electric current flows. The magnetic flux that occurs thereby is guided in a targeted manner in a magnetic circuit, also known as an iron core. This core consists of materials that can conduct the magnetic flux well, for example layered electrical sheet. The layering serves to avoid undesirable eddy currents.

Standard cores are produced from punched individual sheets, which were previously insulated by paper layers glued on one side and, in more modern form, by chemically applied phosphating layers. The sheet thickness for normal applications is frequently 0.5 mm. Thinner sheets with a thickness of 0.35 mm are used for electrical transmitters of higher frequencies or particularly low-loss devices. Cut-tape and toroidal cores are often wound from even thinner and also insulated tapes.

Stencil printing and screen printing are new methods for producing electrical sheets for electric machines. Here, first a printing paste based on metal powders is created. This is then printed onto a carrier plate using a stencil- or screen-printing technique. The printing paste is then converted into a thick layer, also known as a green body. The resulting green body is then transformed into a metallic structured body by thermal treatment.

Herein, the printing paste is conventionally applied to a carrier plate consisting of Al₂O₃, for example. It is known that a scattering agent, for example an Al₂O₃ powder, can be applied to the surface of the carrier plate before the application of the printing paste in order to facilitate the separation of the thermally treated printing paste from the carrier plate. The printing paste is printed directly onto the carrier plate prepared in this way by stencil or screen printing, dried and then thermally processed. One challenge with these methods is to find a carrier plate and, if necessary, a scattering agent with suitable properties both for stencil or screen printing and for the subsequent thermal treatment of the printing paste.

### SUMMARY

The teachings of the present disclosure may be used to overcome this challenge. For example, some embodiments include a method for producing an electrical sheet from a printing paste with the following steps: applying a printing paste to a substrate by a printing method, drying the printing paste on the substrate, transferring the dried printing paste from the substrate to a sintering underlay, thermally treating the printing paste on the sintering underlay, and separating the thermally treated printing paste from the sintering underlay.

In some embodiments, the surface of the dried printing paste which is intended for contact with the sintering underlay is acted upon by a separating layer to facilitate separation of the thermally treated printing paste from the sintering underlay.

In some embodiments, the surface of the sintering underlay, which is intended for contact with the dried printing paste is acted upon by a separating layer to facilitate separation of the thermally treated printing paste from the sintering underlay.

In some embodiments, the separating layer contains a material that is chemically inert at the temperatures occurring during the thermal treatment.

In some embodiments, the separating layer contains a material in the form of platelets, whiskers, fibers or a powder.

In some embodiments, the separating layer contains a material selected from MgO, Y₂O₃, Al₂O₃, BN, YAG, Si₃N₄, SiC, C or a combination thereof.

In some embodiments, the sintering underlay contains a material that is chemically inert at the temperatures occurring during the thermal treatment.

In some embodiments, the sintering underlay contains a material selected from Si₃N₄, SiC, porous Al₂O₃, porous MgO, mullite, fiber-reinforced composite or a combination thereof.

As another example, some embodiments include an electrical sheet for a rotating electric machine for converting energy, wherein the electrical sheet was produced using a method as described herein.

As another example, some embodiments include an electrical sheet for a transformer for converting an input AC voltage into an output AC voltage which was produced using a method as described herein.

### DETAILED DESCRIPTION

Some embodiments of the teachings of the present disclosure include a method with the following steps:
a) applying a printing paste to a substrate by a printing method,
b) drying the printing paste on the substrate,
c) transferring the dried printing paste from the substrate to a sintering underlay,
d) thermally treating the printing paste on the sintering underlay, and
e) separating the thermally treated printing paste from the sintering underlay.

In contrast to the known approach for the production of a screen-printed or stencil-printed electrical sheet, the methods described herein do not attempt to embody the carrier plate on which the printing paste is printed, dried, and thermally treated such that it has optimal properties for both the printing process and the thermal treatment. Instead, a completely different approach is suggested: after the printing paste has been printed and dried on the carrier plate, the dried printing paste is detached from said carrier plate and transferred to another underlay. The thermal treatment of the printing paste then takes place on this separate underlay. Consequently, there are two “carrier plates”: a first carrier plate, hereinafter the “substrate”, and on which the process of printing and drying the printing paste takes place, and a second carrier plate, hereinafter the “sintering underlay”, and on which the thermal treatment of the dried printing paste is performed.

In some embodiments, the sintering underlay can be optimized primarily with respect to the thermal treatment of the printing paste and the substrate can be optimized primarily with respect to stencil or screen printing. In some embodiments, it is, for example, possible to select surface properties of the substrate, such as roughness, planarity (also known as planicity), and absorbency with respect to the organic components and the solvent in the printing paste such that a desired wetting, adhesion or contact angle of the printing paste relative to the substrate is achieved. As a result, it is inter alia possible to achieve an improvement of the edge steepness and precision of the printed structures.

Further advantages of the separation or parallelization of the printing process and the thermal treatment are the reduction in the need for sintering underlays and an improvement in the utilization of the screen printer and sintering furnace. On the one hand, there is namely the possibility of stack sintering, i.e. multiple green parts are stacked one on top of the other on one sintering underlay. On the other hand, if, for example, there are problems with the screen printer, green parts can still be fed to the sintering furnace from a buffer store.

To avoid any misunderstanding, a clarification follows with respect to the term “electrical sheet” used in this disclosure: “electrical sheets” refers not only to rolled sheets as known from the prior art, but also to molded parts created by means of printing techniques having the function and properties of conventional electrical sheets. Screen- or stencil-printed electrical sheets can also be referred to as “material layers”; this term should be considered to be synonymous with “electrical sheets”. In specialist circles, electrical sheets are also known as “magnetic sheets” or, depending on the intended use, as dynamo or motor sheets or transformer sheets.

The printing method mentioned in step a) of the method in particular includes screen-printing methods and stencil-printing methods. Screen printing is a printing method in which a printing paste is printed onto the material to be printed, here the substrate, through a screen, for example a fine-mesh fabric, using a squeegee. At points of the fabric which, according to the print image, are not to be printed with printing paste, the mesh openings of the fabric are made impermeable by a stencil. The fabric supports the stencil made of plastic for the production of which the entire surface of the clamped fabric is coated with a photopolymer and exposed to the motif to be printed via a positive film. The photopolymer cures at the points that are not to be printed and the unexposed material is rinsed out. During the printing process, the printing paste only passes through the fabric where it has been rinsed clear.

In stencil printing without a supporting screen, the stencil itself must be sufficiently strong and is, for example, made of steel and clamped directly into the frame. However, the possible print images are limited with stencil printing. The substrate on which the printing paste is printed can be self-supporting, for example, plate-shaped. Alternatively, flexible substrates are also possible, for example films.

In some embodiments, the printing paste is generally based on a metal powder.

In some embodiments, step b) of the method, drying the printing paste, is, for example, implemented by means of a controlled, in particular temperature-controlled, gas flow for the removal of volatile substances. For this purpose, air or inert gas can be used as the medium. This results in the evaporation of the solvents contained in the printing paste. Here, under some circumstances, it may be necessary to increase the temperature of the printed paste. Optionally, in addition to the evaporation of the solvents, chemical crosslinking reactions of organic binders contained in the printing paste may also take place. Herein, the most homogeneous temperature distribution in the printing paste and slow heating without bubble formation in the solvent play an important role.

In some embodiments, depending upon the thickness of the printed layer, a drying time of 2 to 20 minutes of the drying process is recommended. After the end of method step b), after the printing paste has dried, the thickness of the printed layer is generally approximately 10% to 50% less than it was before step b).

In step c) of the method, the dried printing paste, also referred to as green compact, green part, or green body, is transferred from the substrate to a sintering underlay. This can take place by detaching the green compact from the substrate or by detaching the substrate from the green compact (if the substrate is a film, for example) or by separating the two bodies from one another on both sides. The separated green compact is then transported from the location of the substrate to the location where the thermal treatment takes place. The latter can, for example, be a sintering furnace. Finally, the green compact is placed on a sintering underlay.

In some embodiments, to facilitate or improve the separation of the substrate and green compact, the substrate, which is, for example, embodied in the form of a plate or film, can have a separating layer and/or a separating agent/lubricant. Possible separating layers include, for example, a film comprising polytetrafluoroethylene (PTFE; also known by the trade name Teflon from the company DuPont), polyethylene terephthalate (PET; for example, Hostaphan® films from the company Mitsubishi Polyester Film), silicone, or metal. Possible separating agents/lubricants include, for example, non-stick or adhesive agents, wetting promoters and similar substances.

In step d) of the method, the green compact is thermally treated. For this purpose, the transferred dried printing paste is heated. The thermal treatment can generally be divided into two substeps. During the first substep, debinding, excess organic binders and additives that were contained in the printing paste and are still contained in the green compact are decomposed and escape substantially without residue. The resulting molded part is also referred to as a “brown compact”.

During the second substep, sintering, the brown compact is heated to a temperature below the melting point, preferably between 80%-90% of the melting point, at which the structure of the electrical sheet is compacted by closing the remaining pores. The structure of a screen-printed or stencil-printed electrical sheet differs from that of a rolled electrical sheet in that the material density of the printed electrical sheet is generally still significantly lower than that of the rolled electrical sheet. In some embodiments, the green compact is heated for a time between 120 and 900 minutes to a maximum temperature of 80%-90% of the melting point of the green compact.

In the last step e) of the method, the thermally treated printing paste, the finished electrical sheet, is detached from the sintering underlay or the latter is detached from the electrical sheet. In some embodiments, the sintering furnace can be charged immediately with the next green compact, the next green compact can be transferred immediately to the sintering underlay that has become free.

The structure of a screen-printed or stencil-printed electrical sheet differs from that of a rolled electrical sheet inter alia in that the material density of a printed electrical sheet is generally significantly lower than that of a rolled electrical sheet. In addition, there are generally also significant differences in the microstructure, the texture, of a printed electrical sheet compared to a rolled electrical sheet. Examples are the rolling texture and grain size in the electrical sheet.

In some embodiments, to facilitate the separation of the finished electrical sheet from the sintering underlay, either the surface of the green compact which is intended for contact with the sintering underlay or the surface of the sintering underlay which is intended for contact with the green compact can be provided with a separating layer. In some embodiments, both the green compact and also the sintering underlay can be provided with a separating layer.

In some embodiments, the separating layer contains, in particular consists of, a material that is chemically inert at the temperatures occurring during the thermal treatment. Here, material is understood to be chemically inert if it does not react, or only reacts to a negligible extent, with potential reactants, for example in the sintering furnace, under the respective conditions of the thermal treatment.

In some embodiments, the separating layer is, for example, present in the form of platelets, whiskers (needle-shaped monocrystals of a few micrometers in diameter and several hundred micrometers to several millimeters in length which grow out of galvanically or pyrolytically deposited metallic layers), fibers, or a powder. Materials that appear to be suitable for a separating layer include, for example, MgO, Y₂O₃, Al₂O₃, BN (boron nitride), YAG, Si₃N₄, SiC, C (as graphite, carbon nanotubes or another carbon modification) or a combination thereof. Other high-melting refractory materials also represent a promising choice for a separating layer.

In some embodiments, the sintering underlay on which the green compact is located during the thermal treatment likewise contains a material that is chemically inert at the temperatures occurring during the thermal treatment. Possible examples are Si₃N₄, SiC, porous Al₂O₃, porous MgO, mullite, a fiber-reinforced composite, or a combination thereof.

The electrical sheets produced by the methods described herein can be used in an electric machine. This includes rotating electric machines, in particular electric motors and electric generators, as well as stationary electric machines, in particular transformers.

The transfer methods for producing screen-printed or stencil-printed electrical sheets can also be used to produce multi-component printed structures in that the individual component structures are printed separately and then joined together sequentially via the transfer step. The joining of the individual component structures may be combined with a final calibration step or pressing step for bonding, i.e. joining or laminating the final composite structure in the green state.

What is claimed is:

1. A method for producing an electrical sheet from a printing paste, the method comprising:
applying a printing paste to a substrate;
drying the printing paste on the substrate;
transferring the dried printing paste from the substrate to a sintering underlay;
d)thermally treating the printing paste on the sintering underlay; and
separating the thermally treated printing paste from the sintering underlay.

2. The method as claimed in claim 1, further comprising treating a surface of the dried printing paste intended for contact with the sintering underlay with a separating layer to facilitate separation of the thermally treated printing paste from the sintering underlay.

3. The method as claimed in one of claims 1, further comprising treating the surface of the sintering underlay intended for contact with the dried printing paste with a separating layer to facilitate separation of the thermally treated printing paste from the sintering underlay.

4. The method as claimed in claim 2, wherein the separating layer comprises a material that is chemically inert at any temperatures occurring during the thermal treatment.

5. The method as claimed in claim 2, wherein the separating layer comprises at least one form selected from the group consisting of: platelets, whiskers, fibers, and powder.

6. The method as claimed in claim 2, wherein the separating layer comprises a material selected from the group consisting of: MgO, Y₂O₃, Al₂O₃, BN, YAG, Si₃N₄, SiC, and C.

7. The method as claimed in claim 1, wherein the sintering underlay comprises a material chemically inert at any temperatures occurring during the thermal treatment.

8. The method as claimed in claim 1, wherein the sintering underlay comprises at least one material selected from the group consisting of: Si₃N₄, SiC, porous Al₂O₃, porous MgO, mullite, and fiber-reinforced composite.

9-10. (canceled)
